(19) United States
(12) Patent Application Publication
(10) Pub. No.: US 2002/0108127 A1
(43) Pub. Date: Aug. 8, 2002

(54) Low bandwidth transmission

(76) Inventors: Yon Lew, Westminster, CO (US); David Hisel, Westminster, CO (US); Mark Morano, Westminster, CO (US)

Correspondence Address: COCHRAN & COLLINS, LLP, Suite 230, 3555 Stanford Road, Fort Collins, CO, 80525, US

(21) Appl. No.: 09/779,409

(22) Filed: Feb. 7, 2001

(51) Int. Cl. H04N 7/16

(52) U.S. Cl. 725/142

(57) ABSTRACT

Disclosed is a system that is capable of providing high resolution video data using a low bandwidth communications channel. A local mass storage device such as an optical storage disk is sent to a user. Data may be stored on the disk in a random fashion. The user is connected to a server through a low bandwidth connection and makes queries based upon metadata index categories. Pointers are provided by the server over the low bandwidth data communications channel to the user. The user employs the pointers to access the high resolution data provided on the local mass storage device. The pointers can be provided over the low bandwidth communications channel at a rate sufficient to allow display of the data at the user's computer. The system can be implemented for various marketing applications, pay-for-view applications, training applications, video or audio conferencing, etc. The system can be employed over the Internet, intranets, managed networks, RF networks, optical networks, etc.

### BACKGROUND OF THE INVENTION

a. Field of the Invention

The present invention pertains generally to communications and more particularly to devices and methods for increasing the effect of bandwidth of a communication without using compression techniques.

b. Description of the Background

There has been an increasing need for greater bandwidth in data communication channels. This increasing need has developed with the advent of high speed computers that are able to process data at a very rapid rate. Increasing demand for more data has resulted in extremely large investments in high bandwidth communication channels such as expensive fiber optic channels.

To meet this demand, compression techniques have been employed to increase effective rates of transfer of data. Effective and reliable compression techniques, however, are limited in the compression ratios that can be achieved which limits the ability of these compression techniques to increase effective transmission rates. Further, encoding and decoding of the compressed data at the transmitting and receiving end, respectively, is required. If the processors at the transmitting and receiving end are not substantially faster than the data communications channel, the overall transmission rate is not improved.

Currently, most users of data communications channels have computers that are capable of processing data at a substantially faster rate than the transmission rate of the data communications channel. For example, there are a large number of users that employ dial-up modems to connect to the Internet. These user's computers are normally capable of processing data at a much faster rate than the rate at which data is transmitted over the dial-up connection. The same is also true for users that employ higher speed communications channels such as DSL connections and cable modem connections. For example, it would be advantageous to log on to an internet site and be able to view the products and services of an organization by viewing full screen, high resolution streaming video. This, of course, is not possible using a dial-up modem or even most of the higher speed communications channels such as DSL and cable modem channels.

Hence, it would be desirable to be able to provide data to customers over a low bandwidth communications channel and provide the effect of a very high speed data connection.

### SUMMARY OF THE INVENTION

The present invention overcomes the disadvantages and limitations of the prior art by providing a system and method that allows the use of low bandwidth communication channels to effectively provide high bandwidth data to a user. This is accomplished by separately providing the user with a large amount of data on a mass storage device and providing pointers over a low bandwidth connection to access the requested data. Metadata index categories are provided in a remotely located server that can be accessed over any type of network connection including the Internet, intranets, managed networks, etc. The user only needs to be connected through a low bandwidth connection to generate queries that are used by a search engine in the server that interacts with the index categories to provide pointers indicating the location of the desired data. These pointers are then transferred from the server over the low band communications channel to the user. Since the pointer information constitutes a small amount of data in comparison to the data to which it points, pointers can be provided over low bandwidth communication channels at a rate that is sufficient to access the locally stored data so that it can be provided for display to the user in a continuous fashion. Data can be stored in various ways on the user's local mass storage data device such as in video segments, portions of video segments that can be as small as a single frame, or separate background and foreground data that can be mixed to provide a combined image.

A concept of the present invention is therefore to deliver core data on a mass storage device to a remote location where a user is located and then transfer command and control information over a low bandwidth channel so that the user can access various portions of the data that is stored in the mass storage device. A metadata index is provided at the server location and is accessed by a search engine in response to queries by the user over a low bandwidth communications channel. The search engine accesses the index categories of a metadata index to obtain pointers that correspond to the location of the requested information on the local mass storage device. The server then transfers these pointers back to the user over the low bandwidth communications channel so that the user may apply these pointers to the local mass storage device to obtain the requested information. The search engine can comprise an intelligent search engine that is capable of cognitive recognition of natural language queries provided by the user. Alternatively, the categories of the metadata index may be available to the user for selection of the various combinations of information that the user wishes to obtain. The index categories can be provided with the local mass storage device or may be transmitted over the low bandwidth connection from the server to the user. The pointers may access video segments at the locations indicated by the pointers on the local mass storage device that correspond to the queries that have been made by the user.

The invention can also be implemented in a more fundamental type of format. In accordance with another implementation, video clips can be parsed on a frame by frame basis or a several frame basis. Various video segments can then be generated using standard video frames. In other words, a video sequence can be generated from a series of standard video frames by just sending the pointers to the user so that the user may access the various sequences to be displayed.

In accordance with another implementation of the present invention, the same concept of accessing individual video frames can be used for combining video sequences from various video frames. For example, standard background information as well as foreground information can be provided and combined to generate a mixed video image. This technique can also be used to combine video segments.

The present invention may therefore comprise a method of displaying data to a user at a user station comprising: providing a mass storage medium to the user station that contains the data; establishing a communication channel between the user station and a server; sending queries relating to metadata index categories established for the data, the queries sent from the user station over the communications channel to the server; obtaining pointers from a metadata index located at the server that indicate the location of data on the mass storage medium that corresponds to the queries, using the pointers to access data from the mass storage medium.

The present invention may further comprise a system for displaying data to a user at a user station comprising: a communications channel; a local mass storage device containing data to be displayed; an input device for generating queries regarding the data that is to be displayed; a computer coupled to the display, the input device, the local mass storage device and the communications channel that transmits the queries over the communications channel, receives pointers in response to the queries, accesses data on the local mass storage device corresponding to the pointers and displays the data on the display that has been accessed on the local mass storage device; a server coupled to the communications channel that receives the queries, obtains pointers from a metadata index corresponding to the queries and transmits the pointers across the communications channel to the user station.

The advantages of the present invention are that only a very small amount of data, compared to the data that is being displayed, is passed over the low bandwidth connection from a server to a remotely located user. The data that is transferred comprises location information (pointers) that point to the location of the data on a local mass storage device. This data is then retrieved from the local mass storage device and displayed to the user. In this fashion, only a small amount of bandwidth is required to transfer the pointer information, while simultaneously achieving the result of displaying a large amount of data at the user location.

Another advantage of the present invention is that data can be periodically updated by merely adding the data to the mass storage device. The data need not be stored in any particular sequence on the mass storage device, but rather, may be stored randomly since the data is accessed in a random fashion. This allows the mass storage system to be easily augmented. In other words, new data can just be added to the end of the existing data. For example, additional data can be passed over the low bandwidth channel during off peak periods or when the system is not in use. Alternatively, mass storage data devices, can be delivered to the user that contain a variety of information such as department store catalogs, music company videos, previews of movies, web page displays, electronic versions of magazines, or any type of high resolution mass data that a vendor may which to display locally to users having low speed connections. Updated disks can be provided to the user that merely add additional data to the existing data.

The present invention may also be implemented with customer relations management (CRM) systems to assist in the selection of the data to be displayed. Indexing categories may not have sufficient resolution, such as the resolution provided by CRM systems, to display preferential data for customers.

The present invention may also be implemented over intranets or other types of networks including managed networks. For example, it may be desirable to display high resolution data at various nodes connected to an intranet or managed network in a manner that does not bog down the intranet or managed network. For example, it may be desirable to display training videos on numerous PCs connected to an intranet within a company. Providing a mass storage device for each of the PCs and only transmitting pointers over the intranet prevents the intranet from being bogged down.

The indexing functions of the present invention also provide flexibility in selection of the material to be viewed. Categorical indexing provides substantial time savings to the viewer and implements intelligence into the viewing process.

The data stored on the local mass storage device can be stored in a completely random fashion so that sequential viewing of the data does not make sense. For example, the data can be stored in a fashion such that video frames are interlaced from disparate data sources. Sequential display of such data is incomprehensible. This may be advantageous in situations where the mass data storage device is delivered to an individual, and it is desirable to charge the user for accessing the data. The user may be charged on a pay-for-view basis by accessing the server on the low bandwidth communications channel to obtain the pointer information that allows the user to view the video data.

Another advantage of the present invention is that the connection to the server can be used to allow the server to do other processing functions. For example, the results of input by a user to a training video can be transmitted back to the server which keeps a record of the proficiency of the user and allows the user to only progress to higher levels of training after the user has reached a certain proficiency.

Another advantage of the present invention is that it may be implemented on a RF network or through an optical connection such as an infrared connection. For example, high resolution streaming video can be viewed on a personal data assistant employing the concepts of the present invention.

The present invention may also be implemented for remote editing functions. For example, a remotely located user may be able to provide video frame sequencing to a server by transmitting pointer information. Video clips can be arranged in any desired fashion and special effects can be added or subtracted from the video stream.

The present invention may also be used for editing and rating control. For example, a user can be delivered a mass storage medium and request that the pointers be transmitted for a G-rated movie or a PG-rated movie, etc. The portions of the movie that do not correspond with the rating are not displayed since the pointers are not passed for those portions.

The present invention may also be used in conferencing applications. For example, a video or audio conference may be set up between a number of users, with each user having a local mass storage device. Pointers can then be provided to each of the users so that each of the users can view the same information, or selected information that is pertinent to the conference which may vary from user to user. This data may be displayed in a window during a video conference, or full screen during a audio conference, without the necessity for a high bandwidth data communications connection for audio conferences, or in the case of a video conference, without overloading the video link. Such an application can be implemented in accordance with Synchronized Multimedia Integration Language (SMIL). SMIL allows for coordination of the display of a variety of media.

### BRIEF DESCRIPTION OF THE DRAWINGS

In the drawings,

FIG. 1 is a schematic block diagram illustrating one implementation of the present invention;

FIG. 2 is a schematic illustration of a metadata index showing metadata categories;

FIG. 3 is a flow diagram illustrating the functions performed by a user's computer that interacts with an intelligent search engine located at the server;

FIG. 4 is a flow chart of the functions performed by the user's computer that interacts with a standard search engine located at the server;

FIG. 5 is a flow chart of the functions performed by the server.

### DETAILED DESCRIPTION OF THE INVENTION

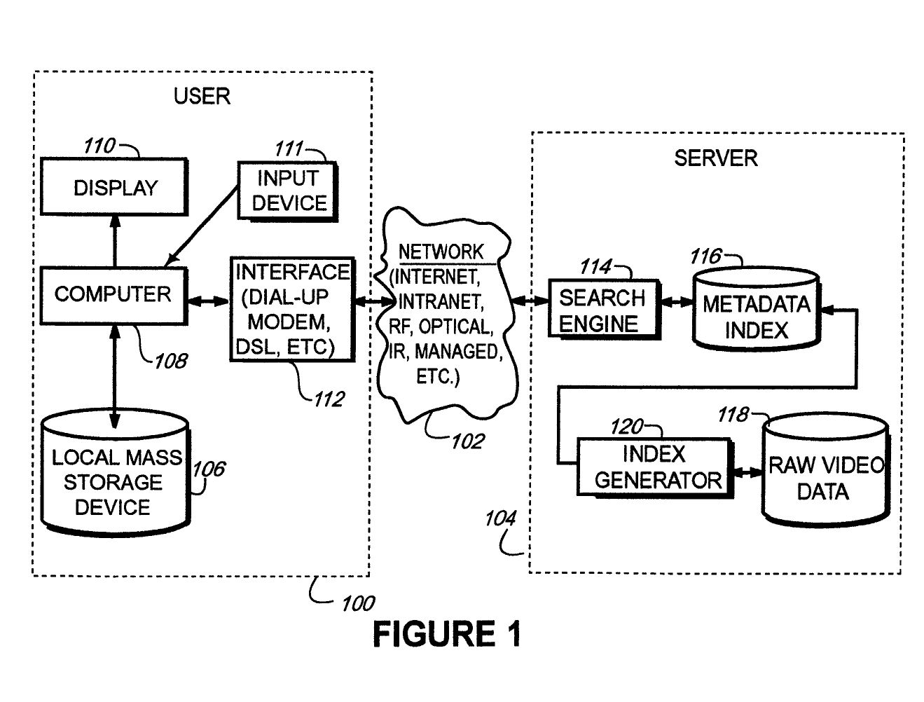

FIG. 1 is a schematic block diagram illustrating one implementation of the present invention. As shown in FIG. 1, a user station 100 is connected through the Internet 102 to a server 104 that is located remotely from the user station 100. The Internet connection 102 can comprise the Internet, a managed network, a local area network, an intranet, a RF connection, or any type of data communications channel over which data can be communicated from a server to a user. The user station includes a computer 108 that utilizes a local mass storage device 106.

As shown in FIG. 1, the local mass storage device may comprise any type of local mass storage that can hold a large amount of data that can be delivered to the user in an inexpensive and easy fashion. For example, the local mass storage device 106 may comprise any type of local storage device which is inexpensive and can be easily delivered to a user on a periodic basis. The local mass storage device 106 stores a large amount of data, such as video data, that can be displayed by the user 100. The data that is stored on the local mass storage device 106 may be stored in a random manner such that sequential viewing of the data does not provide an intelligible video display. For example, video segments may be interleaved on a frame by frame basis and provided in a random manner such that sorting of the video frames must be done by using an index. Alternatively, video segments can be randomly placed on the local mass storage device 106 in any manner that is convenient for the content supplier. Indexing information is also required to sort the video segments into an intelligible sequence. Random placement of the video frames on a frame by frame basis provides greater protection of the data if the content supplier is concerned about a user accessing the data, without index information being provided by a server, such as in a pay-for-view scenario. However, frame by frame mixing, in this manner, requires the transmission of pointers for every frame which increases the bandwidth that is required to provide the video information. Mixing of video segments on the local mass storage device 106 does not provide as much security as mixing on a frame by frame basis, but significantly fewer pointers need to be transmitted over the low band transmission channel.

As mentioned above with regard to FIG. 1, any type of data storage system can be used as the local mass data storage 106. Digital Video Disks (DVDs), CD-ROMs, magneto-optical media, worm media, large-scale optical media, other optical media including any type of holographic or other optical storage techniques, high speed tape, flash memory, or any desirable type of storage media can be used. Rewritable media can be exchanged if desired. However, inexpensive throw-away media, such as DVD disks, or any future mass storage media that is capable of storing a large amount of data, can be utilized.

The user station 100 includes a display 110 that is connected to the computer 108. As shown in FIG. 1, the computer 108 is connected to the network 102 by way of a dialup modem. Of course, any type of connection can be used to connect to any type of network and still fall within the spirit of the present invention. For example, DSL connections, cable modem connections, T1 connections, etc., all have a limit as to the amount of data that can be transmitted over a predetermined period of time (bandwidth). Typically, communications channels, such as the dial-up modem connection 112 to the Internet 102, have a much lower transfer rate than the processing speed of the computer 108. In most situations, this difference may be several orders of magnitude. The data transfer rate of the communications channel is usually only a fraction of the processing speed of the computer. For this reason, the communications channel is considered to be a low bandwidth communications channel when compared to the processing speed of the computer. For example, many computers that are available today are capable of reading DVD disks and displaying full-scale video images with at least broadcast resolution. Using dial-up modem technology, it may take on the order of tens of seconds to display a single frame. Hence, it would be desirable to allow users to employ low bandwidth communications connections such as dial-up modems, DSL connections, or even cable modem connections to display high resolution video using computer 108.

This is accomplished by the server 104 generating pointers that are transmitted through network 102 to the user station 100. The server 104 includes a metadata index 116 that stores pointers for the data that is contained in the local mass storage device 106. Queries from computer 108 are transmitted through the network 102 to a search engine 114. If the search engine 114 is a highly intelligent search engine, it is able to read and translate the questions from the user to obtain the desired information. Otherwise, the index categories may be provided to the user 100 so that these index categories can be combined in a boolean fashion to obtain the requested information. In either case, search engine 114 determines the appropriate set of data for retrieval and accesses the metadata index 116 to obtain the pointers for that requested set of data. Metadata index 116 provides the pointer information that is transmitted to the search engine 114. Search engine 114 then passes these pointers through the network 102 back to the user station 100. The user station 100 then uses these pointers to access information in the local mass storage device 106. Since the pointers comprise a very small amount of information compared to the data to be displayed, the pointers can be passed over the network 102 through an interface device 112, such as a dial-up modem, at a speed that is sufficient to allow computer 108 to access the data in the local mass storage device in a fashion that allows the computer 108 to display full screen high resolution video on display 110.

As is also shown in FIG. 1, the server 104 includes a copy of the raw video data 118 that is stored in the local mass storage device 106. This video data is accessed by an index generator 120. The index generator 120 generates the index categories and accesses the raw video data 118 to obtain pointers to the video data that corresponds to each of the index categories. A plurality of index categories can be initially established by the content provider or other entities, such as the entity operating the server, or even the user. In any event, a number of categories are established. The index generator 120 then proceeds through a process of accessing the raw video data 118 and determining which video segments are encompassed by each of the index categories. The location of the data for each video segment is then recorded for each applicable index category. This information is then passed to the metadata index 116. The process performed by the index generator 120 can be assisted by input from the content provider or, in some cases, may be performed in a fully automated fashion. For example, the index generator 120 may include image recognition capabilities that allow the index generator to recognize content of the video data so that applicable index categories for each video segment can be assigned.

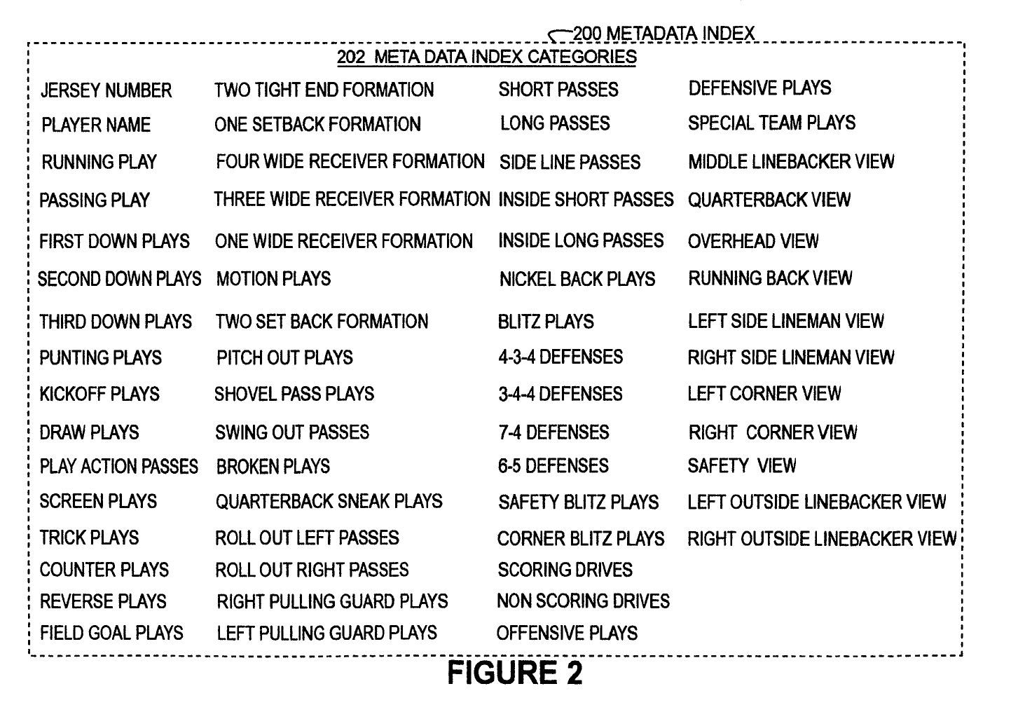

FIG. 2 is a schematic illustration of a metadata index 200. The metadata index 200 includes a series of metadata index categories 202. The metadata index categories 202, for the example shown in FIG. 2, represent categories that may be used for categorizing video segments of football plays. The various categories 202 that are shown in FIG. 2 correspond to different plays, different formations and different views of video clips of a football game. A viewer that wishes to view certain plays, of a large number of plays that have been recorded for a particular team, can select the category or multiple categories for which that user has an interest. For example, the user may select “passing play,” “three wide receiver formation,” “long passes,” “scoring drives.” Any number of different categories can be selected and the search engine 114 (FIG. 1) will select the proper video sequences to be displayed. The various categories can be “and-ed” or “ored” using boolean algebra to obtain the desired search results. If the search engine 114 (FIG. 1) is a cognitive type of search engine that has additional intelligence, questions can be posed in natural language form, rather than referring to specific metadata index categories 202. Such cognitive type of search engines are able to parse the various questions and translate these queries so that they correspond to metadata index categories.

As indicated above, the metadata index categories 202 can be provided to the computer 108 for display on display 110 so that the user can select the various categories desired. The categories can be provided on the local mass storage device 100 or can be downloaded via the network connection 102.

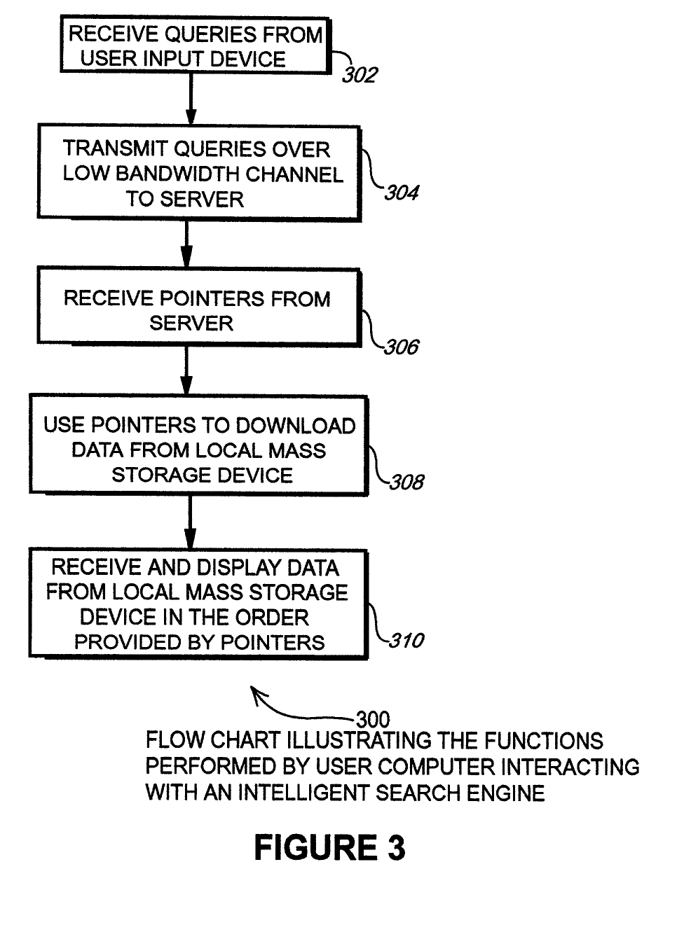

FIG. 3 is a flow chart that describe the functions that are performed by user computer 108 in the process of interacting with an intelligent, cognitive search engine 114. At step 302 the user inputs the queries through an input device 111 that is connected to computer 108. At step 304 the computer 108 processes these queries and transmits the queries via the interface 112 and network 102 to the server 104. At step 306, pointers are received from the server by the computer 108 via the network 102 and interface 112 that indicate the location of the requested information on the local mass storage device 106. At step 308 these pointers are used by the computer 108 to download data from the mass storage device 106. At step 310, the requested data from the local mass storage device 106 is received by the computer 108. This data is then transmitted to display 110 for display.

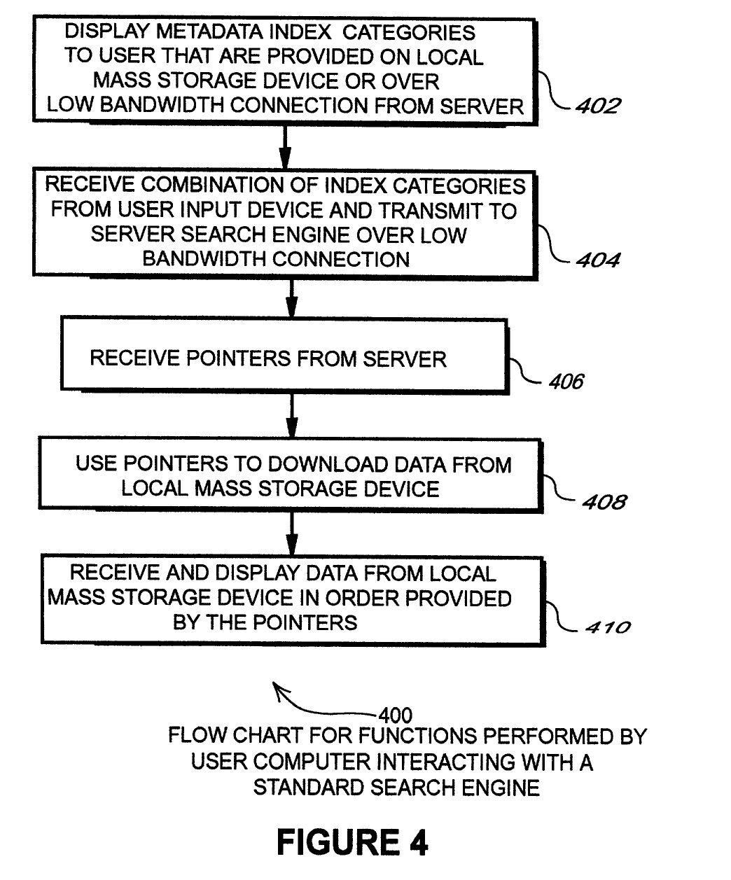

FIG. 4 is a flow chart of the processes 400 that are performed by the user computer 108 when interacting with a standard search engine 114. At step 402, the index categories 202 (FIG. 2) are displayed to the user on display 110. These metadata index categories 202 can be provided on the local mass storage device 106, or can be downloaded via the low bandwidth network connection 102/112 to the computer 108 from the server 104. At step 404, computer 108 receives a combination of index categories from the user input device 111 and transmits this combination of metadata index categories to the server search engine 114 via interface 112 and network 102. At step 406, pointers are received by computer 108 via interface 112 and network 102 from server 104. At step 408, these pointers are used by the computer 108 to download data from the local mass storage device 106. At step 410, the computer 108 receives the requested data from the local mass storage device 106 in the order provided by the pointers and displays this data on display 110.

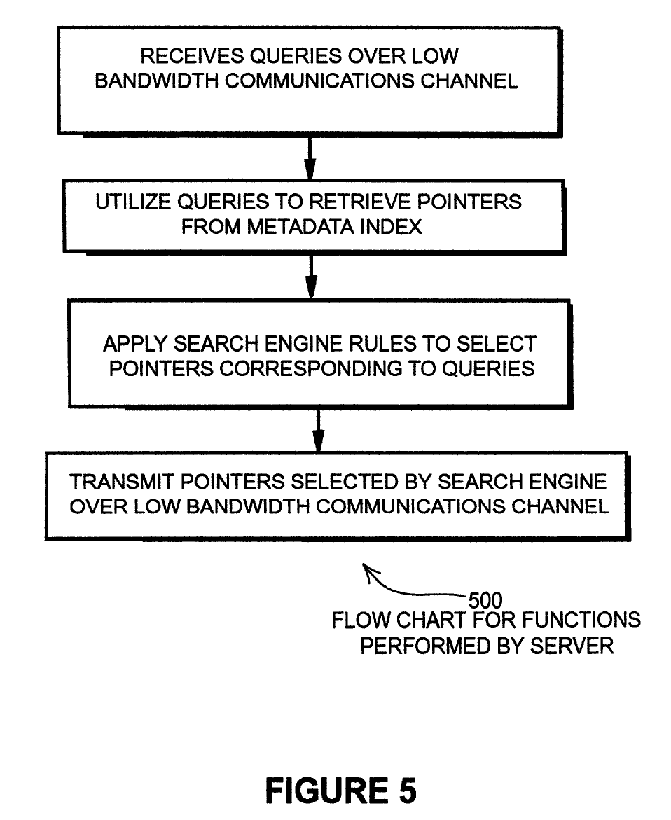

FIG. 5 is a flow chart illustrating the functions 500 that are performed by the server 104. At step 502 the server 104 receives queries over the low bandwidth communications channel comprising interface 112 and network 102. At step 504, search engine 112 utilizes the queries to retrieve pointers from the metadata index 116. The search engine 114 operates in the manner of a standard search engine by combining the metadata index categories 202 in accordance with the boolean combinations that have been presented by the user station 100. At step 506, the search engine applies the search engine rules to select the pointers that correspond to the queries that have been made by the user station 100. At step 508, the search engine 114 transmits the pointers over the network 102 and interface 112 to the computer 108.

The present invention therefore provides a unique method and system that allows users to display large amounts of data, such full screen high resolution video data, using a low bandwidth communications channel. A local mass storage device 106 is provided to the user that contains the high resolution data to be displayed. Pointers that point to the location of the data to be displayed are transmitted via the low bandwidth communications channel. In this fashion, only a small amount of data needs to be transmitted over the low bandwidth communications channel in order to provide a display of a large amount of data at the user location. The local mass storage device 106 can be provided to the user on a periodic basis, such as by mailing a disk to the user, or downloading the information during off peak periods. The data is stored on the local mass storage device in a random fashion so that sequential viewing of the data would not make sense. The data can even be stored on a random frame by frame basis which would result in an unintelligible result if the data were displayed in a sequential fashion. Random storage, in this fashion, may be useful for pay-per-view applications.

Another application of the present invention is the use of the system shown in FIG. 1 in an intranet application using training videos. An intranet network may become bogged down if separate video feeds are provided to various users. For example, various users may wish to separately view a training video. Only certain portions of the training video may need to be viewed by any particular user, and that user may wish to pause, fast forward, reverse, etc., the video during viewing. Hence, separate video feeds are required and the stored data must be simultaneously transmitted to a plurality of users over the intranet. This can require a great deal of processing power for the server and a wide bandwidth, high speed intranet. The present invention is able to overcome those disadvantages by providing the training video on separate local mass storage devices 106 that are located at each user station 100. For example, optical storage disks can be given to each user. Each user can then obtain pointer information to display the requested portions of the video. For example, fast forward, rewind, pause, skip to a pertinent part, are all functions that can be performed with a very small amount of data transmitted over an intranet 102. Further, the processing power of the server that is required to perform these functions is much less than the server processing power that would be required to handle multiple streams of high resolution video. Using this type of intranet application, the index information may be stored locally at a local server to control the access to the data.

The present invention may also be implemented as a system for providing movies at a requested rating level of the user. For example, a local mass storage device 106, such as an optical storage disk, can be provided to a user 100. The user then may make a request to view the movie at a particular rating level, for example a G rating level. This query may be transmitted by computer 108 through interface device 112 and network 102 to the server 104 that provides the pointers to the information on the local mass storage device 106 that comprise the video sequences that correspond to the G rating. Again, pay-for-view charges can be recorded by the server in this implementation.

Another implementation of the invention is to provide previews of movies, music, or other information by way of a CD or other optical storage disk that is mailed to the user. The user can then select the type of movie, or the type of scenes, such as romantic scenes, action scenes, etc. to preview the movie. For music, a disk may include excerpts from country and western, rap, or other type of music. The user can select the type of music of interest and play excerpts from different songs.

Additionally, custom CDs can be generated in this fashion. For example, a user may wish to listen to a certain type of music as well as a selected artist or series of artists. The pointers can be provided to play that music on a pay-for-play basis or as a means for transferring the information on a one-time basis to the user. For example, the user may be sent a CD or DVD that has numerous different types of music and artists. The user may then wish to make selections for a particular event, such as a party, and play the selected artists at that event at a cost that may be much lower than purchasing a number of different audio CDs.

Interactive training sessions can also be performed using the present invention. For example, video graphics may be provided for performing a function, as indicated above. A training session may be provided for bolting the rear seats of a mini-van to the passenger frame. In the initial introductory training phase, information may be provided as to where each of the parts is assembled. In the second phase of training, multiple choice questions may be provided that quiz the user on the placement of each of the parts. In the next phase, click and drag, or click and point, techniques may be employed to allow the user to be tested on assembly of the product and the proper sequence of assembly. Interactive training allows for analysis of the proficiency of the user. Branching to different video sequences can also be allowed. Branching will allow for both qualitative and quantitative analyses. Additionally, branching will allow analysis to be performed by designers as to which method is better for assembly of products.

Another implementation of the present invention is in editing. Thumbnails of video sequences can be provided to the editor/user, who can view each of the video sequences and select and arrange those video sequences in a desired order. For example, several love scenes or several endings may be provided to the editor. The editor can then select a desired sequence from the various options based upon the thumbnails that are provided. Frame by frame editing may also be provided using a higher resolution system. Special effects can also be added. Since the pointers provide the sequence of video segments or even video frames that are displayed, the user may be able to reorganize or rearrange content as desired. This may be useful in remote editing applications.

The present invention may also be implemented with customer relations management (CRM) systems. CRM systems track and learn the preferences of users or buyers. These types of systems can assist in the selection of data to be displayed. For example, indexing categories that are provided for the data may not include some of the preferences of a particular user. For example, a user may be viewing a video catalog from a department store. The user may select red ties. A CRM system may recognize that the user primarily buys ties from a particular manufacturer such as Pierre Cardin. Database information may then be able to retrieve only the Pierre Cardin ties even though that information has not been listed as a metadata index category.

The present invention may also be implemented on a RF network or through an optical connection, such as an infrared connection. Using these concepts, for example, streaming video can be viewed on a personal data assistant or a cell phone.

The present invention may also be implemented in conferencing applications. For example, a video or audio conference may be established between a number of users with each user having the same local mass storage device. Pointers can then be provided through a low band communication channel to each of the users so that each of the users can view the same information or selected information that is pertinent to the conference which may vary from user to user. This data may be provided in a window during a video conference, or full screen during an audio conference, without the necessity for a high bandwidth data communications connection for the audio conferences, or in the case of a video conference, without overloading the video link.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of displaying data to a user at a user station comprising:
providing a mass storage medium to said user station that contains said data;
establishing a communication channel between said user station and a server;
sending queries relating to metadata index categories established for said data, said queries sent from said user station over said communications channel to said server;
obtaining pointers from a metadata index located at said server that indicate the location of data on said mass storage medium that corresponds to said queries:
using said pointers to access data from said mass storage medium.

2. The method of claim 1 wherein said step of establishing a communications channel comprises:
establishing a dial-up connection between said user station and said server.

3. The method of claim 1 wherein said step of establishing a communications channel comprises:
establishing a DSL connection between said user station and said server.

4. The method of claim 1 wherein said step of obtaining pointers comprises:
using a search engine to apply boolean logic to said queries and obtain pointers from said metadata index.

5. A system for displaying data to a user at a user station comprising:
a communications channel;
a local mass storage device containing data to be displayed;
an input device for generating queries regarding the data that is to be displayed;
a computer coupled to said display, said input device, said local mass storage device and said communications channel that transmits said queries over said communications channel, receives pointers in response to said queries, accesses data on said local mass storage device corresponding to said pointers and displays said data on said display that has been accessed on said local mass storage device;
a server coupled to said communications channel that receives said queries, obtains pointers from a metadata index corresponding to said queries and transmits said pointers across said communications channel to said user station.

6. The system of claim 5 wherein said server further comprises:
a search engine that receives and processes said queries in accordance with metadata index categories, and retrieves said pointers from said metadata index.

7. The system of claim 5 further comprising:
an index generator that generates metadata index categories from said data.

8. The system of claim 7 wherein said server further comprises:
a search engine that receives and processes said queries in accordance with metadata index categories and retrieves said pointers from said metadata index.
